(19) United States
(12) Patent Application Publication
(10) Pub. No.: US 2020/0019173 A1
(43) Pub. Date: Jan. 16, 2020

(54) DETECTING ACTIVITY NEAR AUTONOMOUS VEHICLES

(71) Applicant: International Business Machines Corporation, Armonk, NY (US)

(72) Inventors: Jim C. Chen, Rochester, MN (US); Quinton G. Kramer, Rochester, MN (US); Justin C. Nelson, Rochester, MN (US)

(21) Appl. No.: 16/033,378

(22) Filed: Jul. 12, 2018

(51) Int. Cl. G05D 1/02; G05D 1/00

(52) U.S. Cl. CPC G05D 1/0214; G05D 1/0088; G05D 2201/0213; G05D 1/0287; G05D 1/0285

(57) ABSTRACT

Look-wide information is used to detect risks and malicious activity towards autonomous vehicles in an autonomous vehicle network. In some embodiments, a server computer receives data from a first autonomous vehicle based on look-wide information gathered using one or more sensors of the first autonomous vehicle. The server computer establishes a potential event zone based on the data received from the first autonomous vehicle. The server computer communicates to a second autonomous vehicle information instructing the second autonomous vehicle to gather look-wide information using one or more sensors of the second autonomous vehicle while the second autonomous vehicle is traveling in the potential event zone. In some embodiments, the server computer marks the potential event zone as a malicious event zone in response to determining visual information gathered in response to an event trigger matches visual information gathered in response to a subsequent event trigger.

### BACKGROUND

The present invention relates in general to the field of autonomous vehicles. More particularly, the present invention relates to detecting risks and malicious activity towards autonomous vehicles in an autonomous vehicle network.

### SUMMARY

Embodiments of the present invention disclose a method, a computer program product, and a computer system for detecting risks and malicious activity towards autonomous vehicles in an autonomous vehicle network using look-wide information. For purposes of this document, including the claims, look-wide information includes information gathered using one or more sensors of an autonomous vehicle each having a sensing field that covers an area outside of the immediate lane in which the autonomous vehicle is traveling. Look-wide information may include, for example, visual information pertaining to cars as well as moving objects outside the road (such as activity on sidewalks, or spaces to the side of the road). In accordance with some embodiments, a server computer receives data from a first autonomous vehicle based on look-wide information gathered using one or more sensors of the first autonomous vehicle. The server computer establishes a potential event zone based on the data received from the first autonomous vehicle. The server computer communicates to a second autonomous vehicle information instructing the second autonomous vehicle to gather look-wide information using one or more sensors of the second autonomous vehicle while the second autonomous vehicle is traveling in the potential event zone. In accordance with some embodiments, the server computer marks the potential event zone as a malicious event zone in response to determining visual information gathered by one or more cameras of the first autonomous vehicle in response to an event trigger matches visual information gathered by one or more cameras of the first or the second autonomous vehicle in response to a subsequent event trigger.

### BRIEF DESCRIPTION OF THE SEVERAL VIEWS OF THE DRAWINGS

Embodiments of the present invention will hereinafter be described in conjunction with the appended drawings, where like designations denote like elements.

FIG. 1 is a functional block diagram illustrating an autonomous vehicle environment, in accordance with an embodiment of the present invention.

FIG. 2 is a flow diagram depicting operational steps of an event zone management program, operating on a server computer within the autonomous vehicle environment of FIG. 1, in accordance with an embodiment of the present invention.

FIG. 3 is a block diagram illustrating components of the server computer of FIG. 1 executing an event zone management program and a driving behavior modification program, in accordance with an embodiment of the present invention.

FIG. 4 is a flow diagram depicting operational steps of a method of activating one or more wide external sensors of an autonomous vehicle using deviation of the autonomous vehicle from baseline vehicle behavior as a trigger to activate the one or more wide external sensors, in accordance with an embodiment of the present invention.

FIG. 5 is a flow diagram depicting operational steps of a method of activating one or more wide external sensors of an autonomous vehicle using an event as a trigger to activate the one or more wide external sensors, in accordance with an embodiment of the present invention.

FIG. 6 is a flow diagram depicting operational steps of a method in which an autonomous vehicle is instructed to record event metrics while traveling in an area associated with a potentially disruptive event and in which the area associated with the potentially disruptive event is marked as a potential event zone, in accordance with an embodiment of the present invention.

FIG. 7 is a flow diagram depicting operational steps of a method in which an autonomous vehicle is instructed to increase an information gathering level and/or operate in accordance with defensive driving habits while traveling in an area associated with a potentially disruptive event and in which the area associated with the potentially disruptive event is marked as a potential event zone, in accordance with an embodiment of the present invention.

FIG. 8 is a flow diagram depicting operational steps of a method in which an area associated with context determined to be applicable to an event trigger is marked as a potential event zone and in which the potential event zone is marked as a malicious event zone, in accordance with an embodiment of the present invention.

### DETAILED DESCRIPTION

Embodiments of the present invention recognize that malicious activity and other risks pose a potential hazard to autonomous vehicles and their passengers. Autonomous vehicles are typically programmed with safety priorities to avoid accidents. One possible risk is that pedestrians crossing a street will purposely step out, perhaps maliciously, in front of autonomous vehicles presuming that such vehicles are programmed to brake to avoid accidents. Another possible risk is that aggressive drivers will take advantage, perhaps maliciously, of the safety priorities of autonomous vehicles when interacting with autonomous vehicles. Aggressive drivers may, for example, bully autonomous vehicles and possibly even force autonomous vehicles off the road.

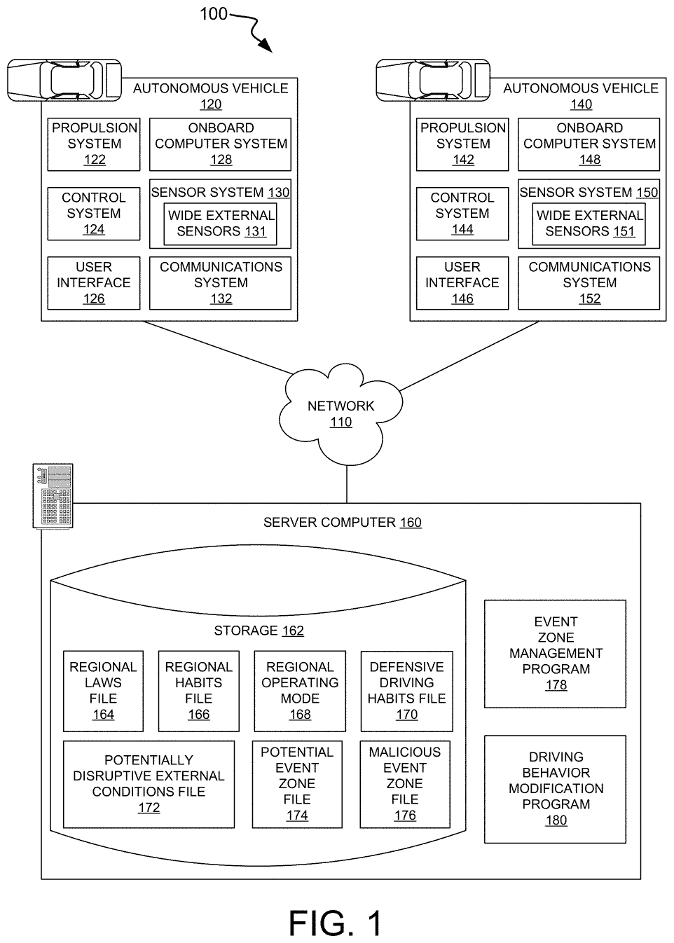

The present invention will now be described in detail with reference to the Figures. FIG. 1 is a functional block diagram illustrating an autonomous vehicle environment (“environment”), generally designated 100, in accordance with an illustrative embodiment of the present invention. Environment 100 includes autonomous vehicles 120 and 140 and server computer 160, all interconnected over network 110. Network 110 can be, for example, a local area network (LAN), a wide area network (WAN), such as the Internet, a dedicated short range communication network, or any combination thereof, and may include wired, wireless, fiber optic, or any other connection known in the art. In general, the communication network can be any combination of connections and protocols that will support communication between autonomous vehicle 120, autonomous vehicle 140, and server computer 160, in accordance with an embodiment of the present invention.

In accordance with some embodiments, network 110 is available to all autonomous vehicles, such as autonomous vehicles 120 and 140. In accordance with some embodiments, information sent and received on network 110 may be collected in a central location (e.g., server computer 160) and all subscribed users (e.g., autonomous vehicles 120 and 140) can access the collected information.

Autonomous vehicles 120 and 140 are motorized autonomous vehicles. In the embodiment illustrated in FIG. 1, autonomous vehicles 120 and 140 are each cars but may be any combination of cars, trucks, or any other kind of vehicle. In various embodiments of the present invention, autonomous vehicles 120 and 140 can be autonomous, semi-autonomous/partially manually operated, or a combination thereof. In one embodiment, autonomous vehicle 120 represents an autonomous vehicle and autonomous vehicle 140 represents another autonomous vehicle. In another embodiment, autonomous vehicle 120 represents an autonomous vehicle and autonomous vehicle 140 represents a semi-autonomous/partially manually operated vehicle. In various embodiments, autonomous vehicles 120 and 140 include propulsion systems 122 and 142, control systems 124 and 144, user interfaces 126 and 146, onboard computer systems 128 and 148, sensor systems 130 and 150 (including wide external sensors 131 and 151), and communications systems 132 and 152, respectively.

In accordance with some embodiments of the present invention, autonomous vehicles 120 and 140 operate according to a profile generated for that particular autonomous vehicle. The profile may, for example, be generated based on a trip's route and purpose. The trip's route may, for example, comprise a driving path that traverses one or more defined regions (e.g., countries, states, counties, cities). Each such defined region may be circumscribed by a defined regional boundary. The trip's purpose may, for example, include factors that characterize the purpose of the trip. For example, is the autonomous vehicle hauling something important or dangerous? Is time a priority? Other factors pertaining to the trip may be used in generating the profile as well. For example, what is the weather like? These factors, along with the route, may be used to generate a profile ranging from ultra-conservative modes to relatively more human-like “slightly-over-the-speed-limit” modes. In one embodiment, autonomous vehicle 120 represents an autonomous vehicle operating according to an ultra-conservative mode within a defined regional boundary and autonomous vehicle 140 represents an autonomous vehicle operating according to a relatively more human-like “slightly-over-the-speed-limit” mode within the same or another regional boundary.

Propulsion systems 122 and 142 include components operable to provide powered motion to autonomous vehicles 120 and 140, respectively. In various embodiments, propulsion systems 122 and 142 can include an engine/motor, an energy source, a transmission, and/or wheels/tires. The engine/motor can be any combination of an internal combustion engine, an electric motor, a steam engine, a Stirling engine, or other types of engines/motors. In some embodiments, propulsion systems 122 and 142 can include multiple types of engines and/or motors, such as a gas-electric hybrid car. The energy source can be, for example, gasoline, diesel, other petroleum-based fuels, propane, other compressed gas-based fuels, ethanol, other biobased fuels, solar panel, and/or batteries. In various embodiments, the transmission can include a gearbox, clutch, differential, and drive shafts.

Control systems 124 and 144 are collections of mechanical, electromechanical, and electronic systems that can be configured to control the operations of autonomous vehicles 120 and 140, respectively. In various embodiments, control systems 124 and 144 can each include a steering unit, a throttle, a brake unit, and/or a navigation system. In an embodiment, the steering unit can be a mechanism that can control the heading and/or turning of the vehicle. In one embodiment, the throttle can be configured to control the operating speed of the engine/motor and, in turn, the speed of the vehicle. In some embodiments, the brake unit can include any combination of mechanisms configured to decelerate the vehicle. The brake unit can use, for example, friction to slow the rotation of the tires/wheels. In some embodiments, the brake unit converts kinetic energy of the wheels/tires into electrical current. In various embodiments, the navigation system can be any system configured to determine the route/driving path for the vehicle. In some embodiments, the navigation system receives input information from GPS, camera systems and other sensors included in sensor systems 130 or 150 in order to generate the route/driving path for the vehicle.

User interfaces 126 and 146 are mechanisms by which a passenger in autonomous vehicles 120 and 140, respectively, can interact with the vehicle. User interfaces 126 and 146 can include buttons, knobs, levers, pedals, paddles, and/or any other type of interface, such as a touchscreen display capable of detecting the location and/or movement of a user's finger. The touchscreen can be, for example, a capacitive sensing screen, a resistance sensing screen, or a surface acoustic wave sensing screen.

Onboard computer systems 128 and 148 are computing systems including at least one computer processor, that is capable of controlling one or more functions of autonomous vehicles 120 and 140, respectively, based on the inputs received from one or more of the systems included in the vehicle and/or based on information (e.g., information about a potential event zone or a malicious event zone, described below) received from server computer 160. For example, in an embodiment, onboard computer system 128 can control propulsion system 122 based on entry of autonomous vehicle 120 into a potential event zone received from server computer 160, as well as inputs received from sensor system 130, including one or more wide external sensors 131.

Sensor systems 130 and 150 include any number of sensors configured to detect information about autonomous vehicles 120 and 140, respectively, and their surrounding environment. In various embodiments, sensor systems 130 and 150 can include a global positioning system (GPS), an inertial measurement unit (IMU), a RADAR unit, a LIDAR unit, a camera, and/or a microphone. The GPS can be any sensor configured to estimate a geographic location. The IMU can be any combination of sensors configured to sense position and orientation changes in a vehicle based on inertial acceleration. The RADAR unit can be any system that uses radio signals to sense objects within the local environment of a vehicle. In various embodiments, the RADAR unit can also detect relative motion between the vehicle and the vehicle's surroundings. The LIDAR unit can be any system configured to sense objects in the vehicle's environment using one or more lasers. The camera can be one or more devices configured to capture a plurality of images of the environment of a vehicle. The camera can be a still or a video camera and may record visible and/or infrared light. The microphone can be one or more devices configured to capture audio of the environment of a vehicle. Audio may be captured using a standalone microphone and/or as part of a video capability, such as the camera.

In addition, sensor systems 130 and 150 can include wide external sensors 131 and 151 that may be activated, for example, when autonomous vehicles 120 and 140, respectively, enter an event zone (e.g., a potential event zone or a malicious event zone) based on information received from server computer 160. In various embodiments, wide external sensors 131 and 151 can include a RADAR unit, a LIDAR unit, a camera, and/or a microphone with a wide sensing field (e.g., a wide field-of-view) that provides additional input about areas beyond the autonomous vehicle's immediate lane to facilitate the tracking of movements within these areas (i.e., in a wider scope than is conventional). Whereas conventional sensor systems are “lane-intensive” in that such systems focus almost exclusively on the autonomous vehicle's immediate lane, wide external sensors 131 and 151 “look wide” and/or “look aside” into areas beyond the immediate lane to enable embodiments of the present invention to track movement within those areas. In accordance with some embodiments, the look-wide information gathered by wide external sensors 131 and 151 may include visual information, with or without audio. Some factors of importance may be picked up from audio. For example, it may be possible to gather audio of someone saying things like, “do it again” or “jump in front of it”, which could help determine context into what is going on.

For example, as an autonomous vehicle progresses through any route, several metrics may be recorded such as route taken, speed, and driving conditions. In one embodiment, the metrics may be sent from autonomous vehicle 120 to server computer 160 via network 110 and the metrics recorded on server computer 160. Wide external sensors 131 can include cameras mounted around autonomous vehicle 120 that provide visual inputs and/or other sensors mounted on autonomous vehicle 120 that provide additional input about the areas outside of the autonomous vehicle's immediate lane. Movements in these areas may be tracked (e.g., by server computer 160 using information received and recorded on server computer 160 from autonomous vehicle 120) in a wider scope than is conventional.

Communication systems 132 and 152 can be any system configured to communicate with one or more devices directly or via network 110. In various embodiments, communication systems 132 and 152 can include a transmitter and a receiver for sending and receiving electromagnetic waves, respectively, such as an antenna.

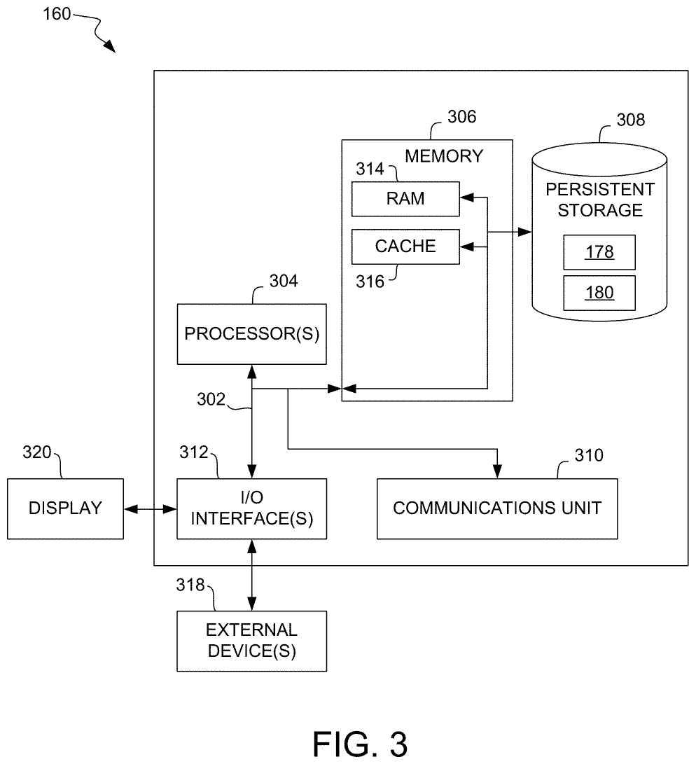

Server computer 160 can be a desktop computer, a laptop computer, a tablet computer, a specialized computer server, a smartphone, or any other computer system known in the art. In certain embodiments, server computer 160 represents a computer system utilizing clustered computer and components that act as a single pool of seamless resources when accessed through network 110, as is common in data centers and with cloud computing applications. In general, server computer 160 is representative of any programmable electronic device or combination of programmable electronic devices capable of executing machine-readable program instructions and communicating with other computer devices via a network. Exemplary components of server computer 160 are described in greater detail with regard to FIG. 3. Server computer 160 includes storage 162, event zone management program 178, and driving behavior modification program 180. Storage 162 includes regional laws file 164, regional habits file 166, regional operating mode 168, defensive driving habits file 170, potentially disruptive external conditions file 172, potential event zone file 174, and malicious event zone file 176.

Storage 162 is a computer readable storage device that maintains information detailing regional traffic laws, regional driving habits, defensive driving habits, and potentially disruptive external conditions, as well as information detailing one or more potential event zones (if any have been established) and/or one or more malicious event zones (if any have been established). In various embodiments, storage 162 can be a portable computer diskette, a hard drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Regional laws file 164 is a collection of information describing various traffic laws for one or more driving regions. Regional laws file 164 can include information on, for example, state and local traffic laws, including speed limits, passing rules, ability to turn at a red light, and yielding right of way. In one embodiment, regional laws file 164 includes a database that comprises a set of regional laws and a set of defined regions, wherein the database indicates which laws apply in which regions, as in a two-dimensional table or array. In one embodiment, server computer 160 may periodically update regional law file 164 via network 110.

Regional habits file 166 is a collection of information describing various regional traffic driving habits that characterize drivers in that region but are not explicitly detailed in regional laws file 164. Regional habits file 166 can include, for example, regional habits, such as how multi-way stop signs are handled, regionally acceptable deviations from the speed limit, passing etiquette, aggressiveness when merging, distance between cars, turn signal timing, use of turn signals, stopping habits, acceleration habits, turning habits, response to emergency vehicles, and customs relating to yielding right of way. In general, regional habits file 166 can include any information that describes how drivers in a region behave in certain situations. In various embodiments, regional habits file 166 can be a database that includes a set of regional driving habits and a set of defined regions, wherein the database indicates to which regions a particular driving habit applies, as in a two-dimension table or array. In one embodiment, server computer 160 may periodically update regional habits file 166 via network 110.

Regional operating mode 168 is a collection of information describing various operational rules that govern the operation of one or more autonomous vehicles operating in a defined region. Regional operating mode 168 instructs vehicle sensors, such a sensor system 130 on autonomous vehicle 120, including wide external sensors 131, to observe the physical surroundings of autonomous vehicle 120 and control the movement and operation of autonomous vehicle 120 according to the operational rules stored in regional operating mode 168. In various embodiments, regional operating mode 168 can include information on the speed of autonomous vehicle 120, safe distance, turn signal timing, brake application timing and intensity, acceleration, merging, and any other operation carried out by autonomous vehicle 120. For example, the operational rules stored in regional operating mode 168 may define a relatively human-like “slightly-over-the-speed-limit” mode that applies some portion or all of the regional traffic driving habits described by the information contained in regional habits file 166.

Defensive driving habits file 170 is a collection of operational rules that define an ultra-safe mode of operation for an autonomous vehicle. In various embodiments, defensive driving habits 170 can include, for example, instructions for conducting an autonomous vehicle according to the applicable traffic laws in a given region, proper spacing between cars to ensure sufficient time to stop, proper timing and use of turn signals, and any other instructions that can ensure safe conduct of autonomous vehicle 120 and passengers therein. In some embodiments, defensive driving habits file 170 includes at least instructions for operating an autonomous vehicle in accordance with all of the regional traffic laws contained in regional laws file 164. In other embodiments, defensive driving habits file 170 includes additional rules that supplement the minimum set of rules to comport with regional laws that guarantee safe driving conduct. For example, the operational rules stored in defensive driving habits file 170 may define an ultra-conservative mode that applies all of the regional traffic laws contained in regional laws file 164 plus additional, more-conservative rules.

Potentially disruptive external conditions file 172 is a collection of information describing potentially disruptive external conditions for one or more driving regions. Potentially disruptive external conditions file 172 can include, for example, external conditions that may cause activity to be picked up by one or more wide external sensors 131 and 151 of autonomous vehicles 120 and 140, respectively. In general, potentially disruptive external conditions file 172 can include any information that describes external conditions that may cause a lot of activity outside the immediate lane in which an autonomous vehicle is traveling, e.g., cars as well as moving objects outside the road (such as activity on sidewalks, or spaces to the side of the road). Potentially disruptive external conditions file 172, in accordance with some embodiments of the present invention, can be a database that comprises a set of potentially disruptive external conditions, a time associated with each potentially disruptive external condition, and an area associated with each potentially disruptive conditions. For example, the set of potentially disruptive external conditions included in the database may include a football game or a concert scheduled at a stadium, a worship service scheduled at a place of worship, recess or dismissal scheduled at a school, playground hours scheduled at a park, and a recently reported traffic accident. The database, for each potentially disruptive external condition, also includes a time associated with the potentially disruptive external condition (e.g., a time range when the football game is expected to end and fans subsequently emerge from the stadium) and an area associated with the potentially disruptive external condition (e.g., a several block perimeter surrounding the stadium where the football game is scheduled). In various embodiments, potentially disruptive external conditions file 172 can be a database that includes a set of potentially disruptive external conditions, a set of times, and a set of areas, wherein the database indicates to which potentially disruptive external condition(s) a particular area and a particular time apply, as in a multi-dimension table or array. In one embodiment, server computer 160 may periodically update potentially disruptive external conditions file 172 via network 110.

Potential event zone file 174 is a collection of information describing one or more potential event zones established by event zone management program 178. Potential event zone file 174 can include information on, for example, one or more potential event zones established by event zone management program 178 based on data received from autonomous vehicle 120 and/or autonomous vehicle 140. In one embodiment, potential event zone file 174 includes information on a potential event zone established by event zone management program 178 based on data received from autonomous vehicle 120, for example, wherein the data received from autonomous vehicle 120 is based on look-wide information gathered using one or more wide external sensors 131 of autonomous vehicle 120. In various embodiments, potential event zone file 174 includes, for each potential event zone, information defining a boundary (which may be static or dynamic) that circumscribes the potential event zone, a strength/confidence level score (which may be static or dynamic) assigned to the potential event zone, the number (and identity) of autonomous vehicle(s) instructed to gather look-wide information while traveling in the potential event zone, the number (and identity) of autonomous vehicle(s) currently traveling in the potential event zone, and/or data received from autonomous vehicle(s) based on look-wide information gathered while each of the autonomous vehicle(s) traveled in the potential event zone (e.g., event metric data, visual information, etc.). In one embodiment, potential event zone file 174 includes a database that comprises a set of potential event zones and a set of autonomous vehicles, wherein the database indicates which autonomous vehicles are currently traveling in which potential event zones, as in a two-dimensional table or array. In one embodiment, server computer 160 may periodically update potential event zone file 174 as autonomous vehicles enter and exit potential event zones.

Malicious event zone file 176 is a collection of information describing one or more malicious event zones established by event zone management program 178. Malicious event zone file 176 can include information on, for example, one or more malicious event zones established by event zone management program 178 based on data received from autonomous vehicle 120 and/or autonomous vehicle 140. In one embodiment, malicious event zone file 176 includes information on a malicious event zone established by event zone management program 178 based on data received from autonomous vehicle 120 and autonomous vehicle 140, for example, wherein the data received from autonomous vehicle 120 is based on look-wide information including visual information gathered using one or more cameras activated in response to an event trigger, wherein the data received from autonomous vehicle 140 is based on look-wide information including visual information gathered using one or more cameras activated in response to a subsequent event trigger, and wherein the visual information gathered in response to the event trigger matches the visual information gathered in response to the subsequent event trigger. In various embodiments, malicious event zone file 176 includes, for each malicious event zone, information defining a boundary (which may be static or dynamic) that circumscribes the malicious event zone, the number (and identity) of autonomous vehicles currently traveling though the malicious event zone, visual information gathered in response to an event trigger and/or one or more subsequent event triggers, the number (and identity) of autonomous vehicles and identity of any third-party entities (e.g., law enforcement entities, insurance companies, etc.) to which information associated with the malicious event zone was communicated, and/or timestamp(s) of when the aforementioned information associated with the malicious event zone was communicated to autonomous vehicles and any third-party entities. In one embodiment, malicious event zone file 176 includes a database that comprises a set of malicious event zones and a set of autonomous vehicles, wherein the database indicates which autonomous vehicles are currently traveling in which malicious event zones, as in a two-dimensional table or array. In one embodiment, server computer 160 may periodically update malicious event zone file 176 as autonomous vehicles enter and exit malicious event zones.

Event zone management program 178 is a computer implemented software application residing on server computer 160. Event zone management program 178 establishes potential event zones and/or malicious event zones, as well as manages any potential event zones and/or malicious event zones that have been established. For example, event zone management program 178 may mark an area as a potential event zone where autonomous vehicle 120 has encountered a lot of activity, as picked up by wide external sensors 131 of autonomous vehicle 120.

Event zone management program 178 may also cause information to be communicated from server computer 160 to one or more autonomous vehicles instructing the one or more autonomous vehicles to gather look-wide information, increase an information gathering level, and/or record event metrics. In one embodiment, event zone management program 178 may cause information to be communicated to autonomous vehicle 140 instructing autonomous vehicle 140 to gather look-wide information using wide external sensors 151 of autonomous vehicle 140 while autonomous vehicle 140 is traveling in a potential event zone that event zone management program 178 established earlier based on data received from autonomous vehicle 120. In another embodiment, event zone management program 178 may cause information to be communicated to autonomous vehicle 120 instructing autonomous vehicle 120 to increase an information gathering level of wide external sensors 131 of autonomous vehicle 120 while autonomous vehicle 120 is traveling in an area associated with a potentially disruptive event determined to have likely caused a deviation by autonomous vehicle 120 from a baseline vehicle behavior. In yet another embodiment, event zone management program 178 may cause information to be communicated to autonomous vehicle 120 instructing autonomous vehicle 120 to record one or more event metrics while autonomous vehicle 120 is traveling in an area associated with a potentially disruptive event determined to have likely caused a deviation by autonomous vehicle 120 from a baseline vehicle behavior.

In addition, event zone management program 178 may assign a strength/confidence level score to each potential event zone that it establishes. The strength/confidence level score may be static or dynamic, i.e., increase/decrease with various factors such as additional information and the passage of time. For example, the strength/confidence level score for the aforementioned potential event zone (e.g., declared by event zone management program 178 for an area where autonomous vehicle 120 encountered a lot of activity, as picked up by wide external sensors 131 of autonomous vehicle 120) may be decreased by event zone management program 178 when no activity is picked up by wide external sensors of one or more other autonomous vehicles when the autonomous vehicle(s) subsequently travel within that same area. Conversely, the strength/confidence level score for the aforementioned potential event zone (e.g., declared by zone management program 178 for an area where autonomous vehicle 120 encountered a lot of activity, as picked up by wide external sensors 131 of autonomous vehicle 120) may be increased by event zone management program 178 when activity is picked up by wide external sensors of one or more autonomous vehicles when the autonomous vehicle(s) subsequently travel though that same area.

As noted above, event zone management program 178 may establish malicious event zones (in addition to, or in lieu of, establishing potential event zones). For example, event zone management program 178 may mark a potential event zone as a malicious event zone in response to determining that visual information gathered in response to an event trigger matches visual information gathered in response to a subsequent event trigger.

Driving behavior modification program 180 is a computer implemented software application residing on server computer 160. In some embodiments, driving behavior modification program 180 directs one or more autonomous vehicles to deviate from the regional operating mode 168 in such a manner as to exhibit vehicle operation that more closely aligns with behaviors detailed in defensive driving habits file 170 than those in regional habits file 166. For example, driving behavior modification program 180 may cause information to be communicated from server computer 160 to autonomous vehicle 120 instructing autonomous vehicle 120 to operate in accordance with defensive driving habits file 170 while autonomous vehicle 120 is traveling in an area associated with a potentially disruptive event determined to have likely caused a deviation by autonomous vehicle 120 from a baseline vehicle behavior, traveling in a potential event zone, or traveling a malicious event zone.

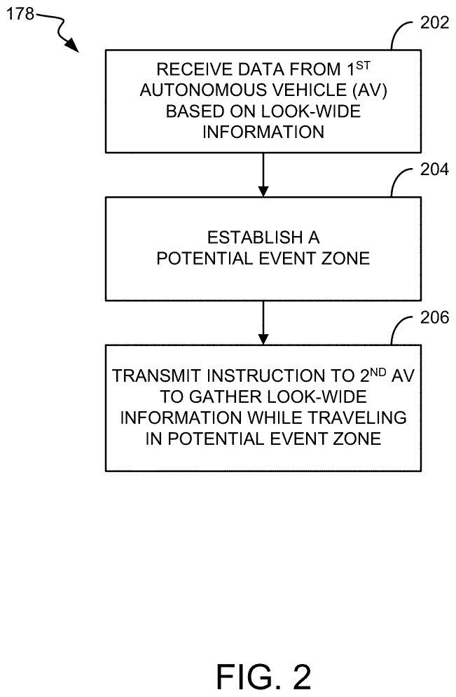

FIG. 2 is a flow diagram depicting operational steps of an event zone management program 178, operating on server computer 160 within autonomous vehicle environment 100 of FIG. 1, according to an illustrative embodiment of the present invention. To begin with, a first autonomous vehicle (e.g., autonomous vehicle 120 of FIG. 1) is operating in a given area. Autonomous vehicle 120 may, for example, operate in the given area according to regional operating mode 168. Regional operating mode 168 is a determined set of rules governing the behavior of autonomous vehicle 120 based on at least the location of autonomous vehicle 120 within a defined region and regional laws file 164 and regional habits file 166, both of which apply in the given area.

Event zone management program 178 receives data from autonomous vehicle 120 based on look-wide information gathered using one or more sensors of sensor system 130 (operation 202). The look-wide information may be gathered by one or more wide external sensors 131 each having a sensing field that covers an area outside of the immediate lane in which autonomous vehicle 120 is traveling. For example, the one or more wide external sensors 131 may include one or more cameras each having a field-of-view that covers an area outside of the immediate lane in which autonomous vehicle 120 is traveling. The one or more wide external sensors 131 may be activated, in accordance with various embodiments of the present invention, in response to a deviation by autonomous vehicle 120 from a baseline vehicle behavior or in response to an event trigger (e.g., a child running into the street or a car veering into the lane of autonomous vehicle 120). Activation of the one or more wide external sensors 131 may be controlled locally within autonomous vehicle 120 (e.g., via onboard computer system 128) or remotely (e.g., via communication between server computer 160 and onboard computer system 128 using network 110).

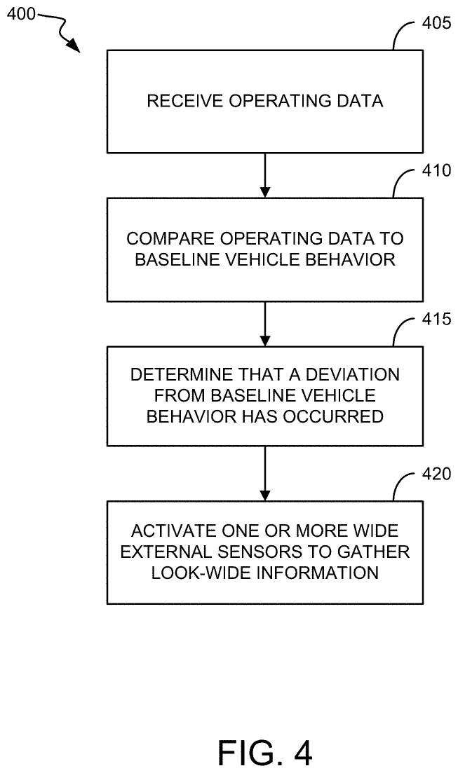

In some embodiments, the one or more wide external sensors 131 may be activated in response to a deviation by autonomous vehicle 120 from a baseline vehicle behavior. The deviation by autonomous vehicle 120 from baseline vehicle behavior may, for example, be due to veering of autonomous vehicle 120 and/or sudden and frequent stops by autonomous vehicle 120. An illustrative embodiment in which deviation of an autonomous vehicle from baseline vehicle behavior is used as a trigger to activate one or more wide external sensors is shown in FIG. 4.

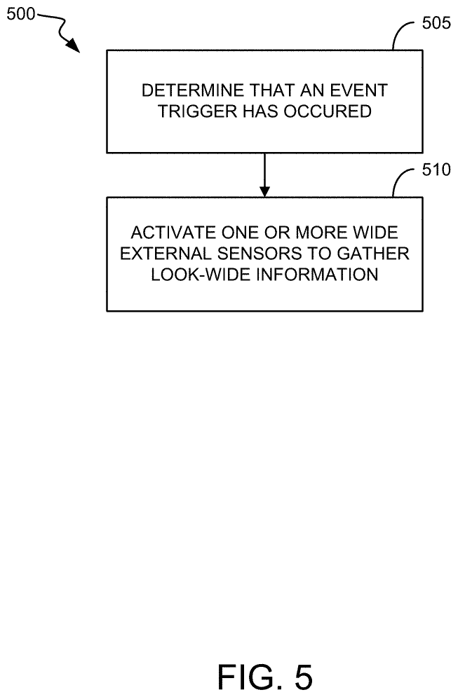

In some embodiments, the one or more wide external sensors 131 may be activated in response to an event trigger. The one or more wide external sensors 131, in accordance with some embodiments, include(s) one or more cameras each having a field-of-view that covers an area outside of the immediate lane in which autonomous vehicle 120 is traveling. The visual information may, for example, cover an area substantially surrounding autonomous vehicle 120 with a focus on a triggering entity. An illustrative embodiment in which an event is used as a trigger to activate one or more wide external sensors is shown in FIG. 5.

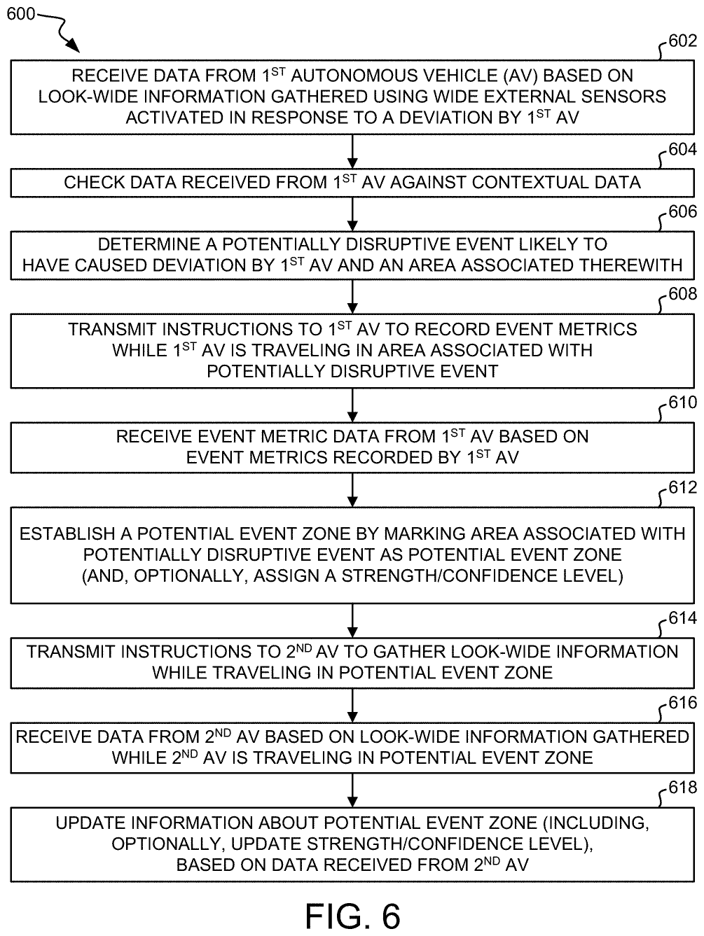

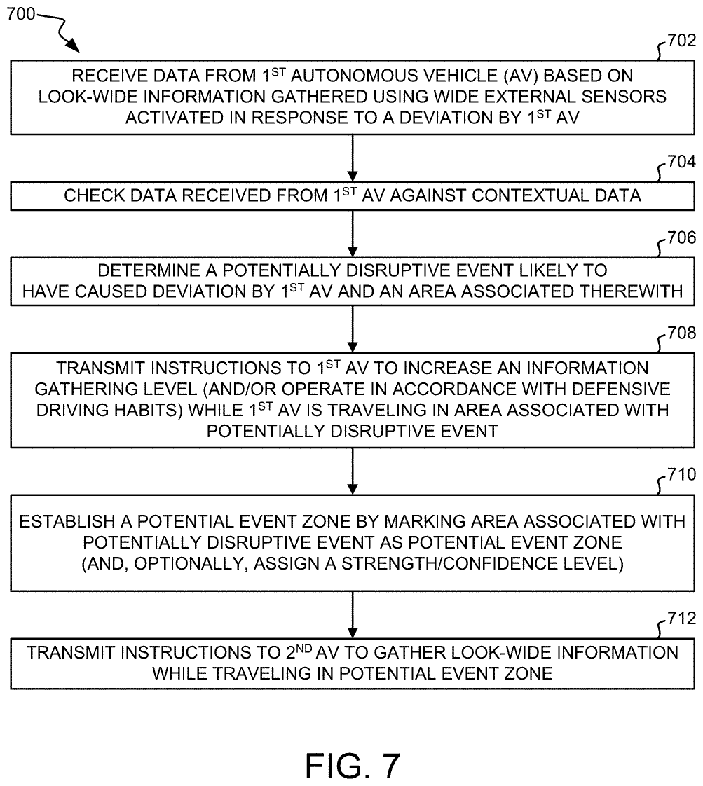

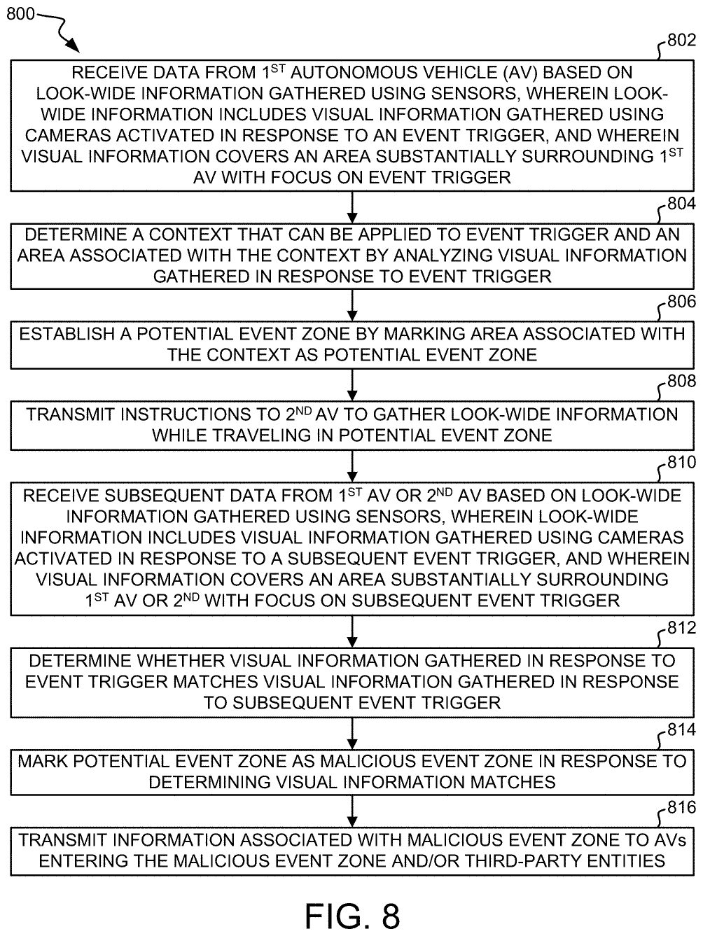

Event zone management program 178 continues, based on the data received from autonomous vehicle 120 (in operation 202), by establishing a potential event zone (operation 204). In some embodiments, event zone management program 178 determines that a deviation by autonomous vehicle 120 from a baseline vehicle behavior was likely caused by a potentially disruptive event and marks an area associated with the potentially disruptive event as a potential event zone. Event zone management program 178, in accordance with some embodiments, may also assign a strength/confidence level to the potential event zone. Illustrative embodiments in which event zone management program 178 marks an area associated with a potentially disruptive event as a potential event zone (and, optionally, assigns a strength/confidence level to the potential event zone) are shown in FIGS. 6 and 7. In some embodiments, event zone management program 178 determines that context can be applied to an event trigger by analyzing visual (and in some embodiments audio) information gathered in response to the event trigger and marks an area associated with the context as the potential event zone. An illustrative embodiment in which event zone management program 178 marks an area associated with context that can be applied to an event trigger as a potential event zone is shown in FIG. 8.

Event zone management program 178 continues, upon establishing a potential event zone (in operation 204), by transmitting information to a second autonomous vehicle (e.g., autonomous vehicle 140) instructing that particular autonomous vehicle to gather look-wide information using one or more sensors while that particular autonomous vehicle is traveling in the potential event zone (operation 206). The look-wide information may be gathered by one or more wide external sensors 151 of autonomous vehicle 140 each having a sensing field that covers an area outside of the immediate lane in which autonomous vehicle 140 is traveling. The one or more wide external sensors 151 may be activated, for example, in response to autonomous vehicle 140 receiving the aforementioned information from server computer 160.

FIG. 3 is a block diagram illustrating components of server computer 160 of FIG. 1 executing event zone management program 178 and driving behavior modification program 180, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server computer 160 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within the system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Event zone management program 178 and driving behavior modification program 180 are stored in persistent storage 308 for execution by one or more of the respective computer processors 304 via one or more memories of memory 306. In this embodiment, persistent storage 308 includes a magnetic hard disk drive. Alternatively, or in addition to a magnetic hard drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including resources of autonomous vehicles 120 and 140. In these examples, communications unit 310 includes one or more network interface cards. Communication unit 310 may provide communications through the use of either or both physical and wireless communications links. Event zone management program 178 and driving behavior modification program 180 may be downloaded to persistent storage 308 through communications unit 310.

I/O interface(s) 312 allows for input and output of data with other devices that may be connected to server computer 160. For example, I/O interface 312 may provide a connection to external devices 318 such as a keyboard, keypad, a touchscreen, and/or other suitable input device. External devices 318 can also include portable computer-readable storage media such as, for example, thumb drives, portable optical or magnetic disks, and memory cards. Software and data used to practice embodiments of the present invention, e.g., event zone management program 178 and driving behavior modification program 180, can be stored on such portable computer-readable storage media and can be loaded onto persistent storage 308 via I/O interface(s) 312. I/O interface(s) 312 may also connect to a display 320.

Display 320 provides a mechanism to display data to a user and may be, for example, a computer monitor.

FIG. 4 is a flow diagram depicting operational steps of a method 400 of activating one or more wide external sensors of an autonomous vehicle (e.g., autonomous vehicle 120) using deviation of the autonomous vehicle from baseline vehicle behavior as a trigger to activate the one or more wide external sensors, in accordance with an embodiment of the present invention. Method 400 may be performed locally within autonomous vehicle 120 (e.g., via onboard computer system 128) or remotely (e.g., via communication between server computer 160 and onboard computer system 128 using network 110).

Method 400 begins by receiving operating data (operation 405). The operating data includes one or more metrics that characterize recent driving behavior of an autonomous vehicle. The operating data may be received locally (e.g., at onboard computer system 128) or remotely (e.g., at server computer 160). Exemplary operating data includes, but is not limited to, the geographic location of the autonomous vehicle, the lane position of the autonomous vehicle within the lane within which the autonomous vehicle is traveling, the speed of the autonomous vehicle, and the deceleration of the autonomous vehicle. Autonomous vehicles conventionally estimate geographic location using GPS. As mentioned earlier, sensor systems 130 and 150 can include a global positioning system (GPS). The exemplary operating data may be readily derived from the estimate of geographic location provided by GPS using techniques well known to those skilled in the art. In embodiments where the autonomous vehicle is a semi-autonomous/partially manually operated vehicle, the operating data may include additional metrics such as pressure applied to the brake pedal, force applied in turning the steering wheel, and the like.

Method 400 continues by comparing the operating data (received in operation 405) to baseline vehicle behavior for the autonomous vehicle (operation 410). This comparing operation may be performed locally (e.g., by onboard computer system 128) or remotely (e.g., by server computer 160). In some embodiments, the baseline vehicle behavior for the autonomous vehicle may include an average baseline for the trip's route or of the current journey calculated using recent operating data. For example, the baseline vehicle behavior for the autonomous vehicle may include an average speed, average lane position, and/or average deceleration for the trip's route calculated based on recent operating data. In some embodiments, the baseline vehicle behavior for the autonomous vehicle may include a range-type baseline for the trip's route or of the current journey. For example, the baseline vehicle behavior for the autonomous vehicle may include a range of speed, a range of lane position, and/or a range of deceleration for the trip's route calculated based on recent operating data. The range-type baseline may be, in accordance with some embodiment, at least partially based on the trip's purpose. For example, the range-type baseline may be relatively tight (i.e., little deviation is allowed) when the purpose of the trip involves hauling something important or dangerous, or where time is a priority. In some embodiments, the baseline vehicle behavior may include the geographic location and/or timeline of expected stops (e.g., stop signs, toll booths) and/or potential stops (e.g., stop lights, rest areas) for the trip's route.

Method 400 continues, based on the comparing operation performed in operation 410, by determining whether a deviation from baseline vehicle behavior has occurred (operation 415). This determining operation may be performed locally (e.g., by onboard computer system 128) or remotely (e.g., by server computer 160). The deviation by autonomous vehicle 120 from baseline vehicle behavior may, for example, be due to veering of autonomous vehicle 120 and/or sudden and frequent stops by autonomous vehicle 120.

Method 400 continues, responsive to determining in operation 415 that a deviation from baseline vehicle behavior has occurred, by activating one or more wide external sensors to gather look-wide information (operation 420). This activating operation may be initiated locally (e.g., by onboard computer system 128) or remotely (e.g., by server computer 160). For example, in some embodiments, onboard computer system 128 may initiate activation of one or more wide external sensors 131 (responsive to onboard computer system 128 determining that a deviation from baseline vehicle behavior has occurred at autonomous vehicle 120). In other embodiments, event zone management program 178 on server computer 160 may initiate activation of one or more external sensors 131 (responsive to event zone management program 178 determining that a deviation from baseline vehicle behavior has occurred at autonomous vehicle 120) by transmitting information to autonomous vehicle 120 instructing autonomous vehicle 120 to activate one or more wide external sensors 131.

FIG. 5 is a flow diagram depicting operational step of a method 500 of activating one or more wide external sensors of an autonomous vehicle (e.g., autonomous vehicle 120) using an event as a trigger to activate the one or more wide external sensors, in accordance with an embodiment of the present invention. Method 500 may be performed locally within autonomous vehicle 120 (e.g., via onboard computer system 128) or remotely (e.g., via communication between server computer 160 and onboard computer system 128 using network 110).

Method 500 begins by determining whether an event trigger has occurred (operation 505). This activating operation may be initiated locally (e.g., by onboard computer system 128) or remotely (e.g., by server computer 160). The event trigger is an event that occurs to the autonomous vehicle. The event trigger may be any one of a defined set of events that might possibly occur to the autonomous vehicle. Exemplary event triggers include, but are not limited to, an obstacle (e.g., a child or other person) running into the street or a vehicle (e.g., a car, a truck, a motorcycle, or a bicycle) veering into the autonomous vehicle's lane.

Detection of events such as these is conventional. Any of a myriad of techniques well known to those skilled in the art may be used to detect the occurrence of such events. Once such an event is detected, conventional autonomous vehicles employ one or more appropriate countermeasures. For example, when an event occurs such as a child or other obstacle running into the street, conventional autonomous vehicles will immediately stop. As is also conventional, if a car or other vehicle veers into a conventional autonomous vehicle's lane, the conventional autonomous vehicle will slow down or make the appropriate countermeasure(s) for avoidance.

Method 500 continues, responsive to determining in operation 505 that an event trigger has occurred, by activating one or more wide external sensors to gather look-wide information (operation 510). This activating operation may be initiated locally (e.g., by onboard computer system 128) or remotely (e.g., by server computer 160). For example, in some embodiments, onboard computer system 128 may initiate activation of one or more wide external sensors 131 (responsive to onboard computer system 128 determining that an event trigger has occurred to autonomous vehicle 120). In other embodiments, event zone management program 178 on server computer 160 may initiate activation of one or more external sensors 131 (responsive to event zone management program 178 determining that an event trigger has occurred to autonomous vehicle 120) by transmitting information to autonomous vehicle 120 instructing autonomous vehicle 120 to activate one or more wide external sensors 131.

In some embodiments, the one or more wide external sensors that is/are activated to gather the look-wide information in response to an event trigger include(s) one or more cameras that is/are activated to gather visual information. The visual information gathered may, for example, cover an area substantially surrounding autonomous vehicle 120 with a focus on a triggering entity. For example, in accordance with some embodiments of the present invention, one or more cameras may be activated to immediately snapshot the entire area around autonomous vehicle 120 with a focus on the triggering entity (e.g., the child and/or the child's face, or the veering car).

FIG. 6 is a flow diagram depicting operational steps of a method 600 in which an autonomous vehicle is instructed to record one or more event metrics while traveling in an area associated with a potentially disruptive event and in which the area associated with the potentially disruptive event is marked as a potential event zone, in accordance with an embodiment of the present invention. Method 600 corresponds to an embodiment of event zone management program 178 of FIG. 1, which may be operating in conjunction with driving behavior modification program 180. Accordingly, method 600 is described below in the context of operating on server computer 160 within autonomous vehicle environment 100 of FIG. 1. To begin with, a first autonomous vehicle (e.g., autonomous vehicle 120 of FIG. 1) is operating in a given area. Autonomous vehicle 120 may, for example, operate in the given area according to regional operating mode 168. Regional operating mode 168 is a determined set of rules governing the behavior of autonomous vehicle 120 based on at least the location of autonomous vehicle 120 within a defined region and regional laws file 164 and regional habits file 166, both of which apply in the given area.

Method 600 receives data from autonomous vehicle 120 based on look-wide information gathered using one or more wide external sensors 131 activated in response to a deviation by autonomous vehicle 120 from a baseline vehicle behavior (operation 602). The one or more wide external sensors 131 may be, for example, activated in accordance with method 400 illustrated in FIG. 4. Activation of the one or more wide external sensors 131 may be controlled locally within autonomous vehicle 120 (e.g., via onboard computer system 128) or remotely (e.g., via communication between server computer 160 and onboard computer system 128 using network 110). The deviation by autonomous vehicle 120 from baseline vehicle behavior may, for example, be due to veering of autonomous vehicle 120 and/or sudden and frequent stops by autonomous vehicle 120. In some embodiments, the look-wide information is gathered by one or more wide external sensors 131 each having a sensing field that covers an area outside of the immediate lane in which autonomous vehicle 120 is traveling. For example, the one or more wide external sensors 131 may include one or more cameras each having a field-of-view that covers an area outside of the immediate lane in which autonomous vehicle 120 is traveling.

Method 600 continues, based on the data received from autonomous vehicle 120 (in operation 602), by checking the data received from autonomous vehicle 120 against contextual information describing potentially disruptive external conditions within a region in which autonomous vehicle 120 is traveling (operation 604). When an autonomous vehicle enters an area in which its wide external sensors are picking up a lot of activity, e.g., cars as well as moving objects outside the road (such as activity on sidewalks, or spaces to the side of the road), method 600 may check available information sources for external conditions that may be causing the activity. For example, method 600 may use data available on one or more mapping applications and other network/internet sources.

Method 600 may, for example, access a database, such as potentially disruptive external conditions file 172, that comprises a set of potentially disruptive external conditions, a time associated with each potentially disruptive external condition, and an area associated with each potentially disruptive conditions. For example, the set of potentially disruptive external conditions included in the database may include a football game or a concert scheduled at a stadium, a worship service scheduled at a place of worship, recess or dismissal scheduled at a school, playground hours scheduled at a park, a recently reported traffic accident. The database, for each potentially disruptive external condition, also includes a time associated with the potentially disruptive external condition (e.g., a time range when the football game is expected to end and fans subsequently emerge from the stadium) and an area associated with the potentially disruptive external condition (e.g., a several block perimeter surrounding the stadium where the football game is scheduled). Method 600 may, in accordance with some embodiments of the present invention, access the database via network 110.

Method 600 continues, based upon checking the data received from autonomous vehicle 120 against contextual information (in operation 604), by determining a potentially disruptive event likely to have caused the deviation by autonomous vehicle 120 from the baseline vehicle behavior, as well as determining an area associated with the potentially disruptive event (operation 606). Using data available on mapping applications and other network/internet sources, for example, method 600 can infer if the autonomous vehicle is approaching areas that are attracting an unusually large number of obstacles at the time, e.g., near a stadium during (or shortly before or after) a game or concert, near a place of worship when it is letting out, near a school during recess or when it is letting out, near a playground of a park during park hours, near the scene of a recently reported traffic accident, etc.

In accordance with some embodiments of the present invention, method 600 determines a potentially disruptive event likely to have caused the deviation by autonomous vehicle 120 by identifying a particular one of the potentially disruptive external conditions included in the potentially disruptive external conditions file 172 has a time and an area associated therewith respectively corresponding to (i.e., encompassing) the time and the location of the deviation by autonomous vehicle 120. In some embodiments, method 600 marks that particular potentially disruptive external condition as the potentially disruptive event and marks the area associated with that particular potentially disruptive external condition as the area associated with the potentially disruptive event.

Method 600 continues, upon determining the potentially disruptive event and the area associated with the potentially disruptive event (in operation 606), by transmitting information instructing autonomous vehicle 120 to record one or more event metrics while autonomous vehicle is traveling in the area associated with the potentially disruptive event (operation 608). The one or more event metrics that autonomous vehicle 120 is instructed to record may include, but are not limited to, a drive time of autonomous vehicle 120 through the area associated with the potentially disruptive event, a proximity of a closest moving obstacle encountered by autonomous vehicle 120 while traveling within the area associated with the potentially disruptive event, and a density of obstacles encountered by autonomous vehicle 120 while traveling within the area associated with the potentially disruptive event. The one or more event metrics may be, for example, recorded in a memory of onboard computer system 128. The one or more event metrics recorded by autonomous vehicle 120 may be relayed as event metric data to server computer 160.

In operation 608, the information transmitted to autonomous vehicle 120 instructing autonomous vehicle 120 to record event metrics is exemplary. In addition to, or in lieu of, instructing autonomous vehicle 120 to record event metrics, event zone management program 178 may in operation 608 instruct any autonomous vehicle approaching or traveling through the area associated with the potentially disruptive event to raise its awareness and sensor levels. For example, event zone management program 178 may instruct autonomous vehicle 120 to increase an information gathering level while autonomous vehicle 120 is traveling in the area associated with the potentially disruptive event. Also, event zone management program 178, working in conjunction with driving behavior modification program 180, may in operation 608 instruct autonomous vehicle 120 to operate in accordance with defensive driving habits while autonomous vehicle 120 is traveling in the area associated with the potentially disruptive event. Such an embodiment of event zone management program 178 is exemplified in operation 708 of method 700 of FIG. 7, described below. Also, any autonomous vehicle that is traveling in the area associated with the potentially disruptive event may likewise use and update information about the potentially disruptive event on server computer 160.

Method 600 continues by receiving event metric data from autonomous vehicle 120 based on the one or more event metrics recorded by autonomous vehicle 120 (operation 610). Method 600 may, for example, store the event metric data in potential event zone file 174 as information about a potential event zone (i.e., a potential event zone that is established in operation 612, described below).

Method 600 continues by establishing a potential event zone by marking the area associated with the potentially disruptive event as the potential event zone (operation 612). In some embodiments, method 600 may copy the area associated with the potentially disruptive event into potential event zone file 174 as a potential event zone and store the event metric data received from autonomous vehicle 120 (in operation 610) in potential event zone file 174 as information about the potential event zone.

In addition, method 600 may optionally assign a strength/confidence level to the potential event zone. Method 600 may, for example, assign a strength/confidence level ranging between 0 (lowest strength/confidence level) and 10 (highest strength/confidence level) to the potential event zone. Method 600 may, for example, assign a strength/confidence level to the potential event zone based on the event metric data received from autonomous vehicle 120 (in operation 610) and record the strength/confidence level in potential event zone file 174. For example, method 600 may assign a strength/confidence level that is relatively high (low) when the drive time of autonomous vehicle 120 through the area associated with the potentially disruptive event is above (below) a predetermined level, the proximity of a closest moving obstacle encountered by autonomous vehicle 120 while traveling within the area associated with the potentially disruptive event is less (more) than a predetermined level, and/or the density of obstacles encountered by autonomous vehicle 120 while traveling within the area associated with the potentially disruptive event is above (below) a predetermined level. The strength/confidence level may be increased and/or decreased over time based on data subsequently received from other autonomous vehicles (i.e., data based on look-wide information gathered by other autonomous vehicles subsequently traveling in the potential event zone).

Method 600 continues, upon establishing a potential event zone (in operation 612), by transmitting information to a second autonomous vehicle (e.g., autonomous vehicle 140) instructing that particular autonomous vehicle to gather look-wide information using one or more sensors while that particular autonomous vehicle is traveling in the potential event zone (operation 614). The look-wide information may be gathered by one or more wide external sensors 151 of autonomous vehicle 140 each having a sensing field that covers an area outside of the immediate lane in which autonomous vehicle 140 is traveling. The one or more wide external sensors 151 may be activated, for example, in response to autonomous vehicle 140 receiving the aforementioned information from server computer 160. Data based on the look-wide information gathered are transmitted from autonomous vehicle 140 to server computer 160. For example, autonomous vehicle 140 may, in accordance with some embodiments, record one or more event metrics (analogous to the one or more event metrics recorded by autonomous vehicle 120 and received as event metric data in operation 610) and relay the event metrics as event metric data to server computer 160.

In operation 612, the information transmitted to autonomous vehicle 140 instructing autonomous vehicle 140 to gather look-wide information is exemplary. In addition to, or in lieu of, instructing autonomous vehicle 140 to gather look-wide information, event zone management program 178 may in operation 612 instruct any autonomous vehicle approaching or traveling through the potential event zone to perform other functions. For example, event zone management program 178, working in conjunction with driving behavior modification program 180, may in operation 612 instruct autonomous vehicle 140 to operate in accordance with defensive driving habits while autonomous vehicle 140 is traveling in the potential event zone. Also, any autonomous vehicle that is traveling in a potential event zone may likewise use and update information about the potential event zone on server computer 160.

Method 600 continues by receiving data from autonomous vehicle 140 based on the look-wide information gathered using the one or more sensors of autonomous vehicle 140 while autonomous vehicle 140 is traveling in the potential event zone (operation 616). Method 600 may receive event metric data, for example, from autonomous vehicle 140.

Method 600 continues, upon receiving the data from autonomous vehicle 140, by updating information about the potential event zone based on the data received from autonomous vehicle 140 (operation 618). Method 600 may, for example, update the information about the potential event zone stored in the potential event zone file 174 using the data received from autonomous vehicle 140. Optionally, method 600 may update the strength/confidence level assigned to the potential event zone. For example, the strength/confidence level assigned to the potential event zone and recorded in the potential event zone file 174 may be updated by method 600 based on event metric data received from autonomous vehicle 140.

FIG. 7 is a flow diagram depicting operational steps of a method in which an autonomous vehicle is instructed to increase an information gathering level and/or operate in accordance with defensive driving habits while traveling in an area associated with a potentially disruptive event and in which the area associated with the potentially disruptive event is marked as a potential event zone, in accordance with an embodiment of the present invention. Method 700 corresponds to an embodiment of event zone management program 178 of FIG. 1, which may be operating in conjunction with driving behavior modification program 180. Accordingly, method 700 is described below in the context of operating on server computer 160 within autonomous vehicle environment 100 of FIG. 1. To begin with, a first autonomous vehicle (e.g., autonomous vehicle 120 of FIG. 1) is operating in a given area. Autonomous vehicle 120 may, for example, operate in the given area according to regional operating mode 168. Regional operating mode 168 is a determined set of rules governing the behavior of autonomous vehicle 120 based on at least the location of autonomous vehicle 120 within a defined region and regional laws file 164 and regional habits file 166, both of which apply in the given area.

Method 700 receives data from autonomous vehicle 120 based on look-wide information gathered using one or more wide external sensors 131 activated in response to a deviation by autonomous vehicle 120 from a baseline vehicle behavior (operation 702). The one or more wide external sensors 131 may be, for example, activated in accordance with method 400 illustrated in FIG. 4. Activation of the one or more wide external sensors 131 may be controlled locally within autonomous vehicle 120 (e.g., via onboard computer system 128) or remotely (e.g., via communication between server computer 160 and onboard computer system 128 using network 110). The deviation by autonomous vehicle 120 from baseline vehicle behavior may, for example, be due to veering of autonomous vehicle 120 and/or sudden and frequent stops by autonomous vehicle 120. In some embodiments, the look-wide information is gathered by one or more wide external sensors 131 each having a sensing field that covers an area outside of the immediate lane in which autonomous vehicle 120 is traveling. For example, the one or more wide external sensors 131 may include one or more cameras each having a field-of-view that covers an area outside of the immediate lane in which autonomous vehicle 120 is traveling.

Method 700 continues, based on the data received from autonomous vehicle 120 (in operation 702), by checking the data received from autonomous vehicle 120 against contextual information describing potentially disruptive external conditions within a region in which autonomous vehicle 120 is traveling (operation 704). When an autonomous vehicle enters an area in which its wide external sensors are picking up a lot of activity, e.g., cars as well as moving objects outside the road (such as activity on sidewalks, or spaces to the side of the road), method 700 may check available information sources for external conditions that may be causing the activity. For example, method 700 may use data available on one or more mapping applications and other network/internet sources.

Method 700 may, for example, access a database, such as potentially disruptive external conditions file 172, that comprises a set of potentially disruptive external conditions, a time associated with each potentially disruptive external condition, and an area associated with each potentially disruptive conditions. For example, the set of potentially disruptive external conditions included in the database may include a football game or a concert scheduled at a stadium, a worship service scheduled at a place of worship, recess or dismissal scheduled at a school, playground hours scheduled at a park, a recently reported traffic accident. The database, for each potentially disruptive external condition, also includes a time associated with the potentially disruptive external condition (e.g., a time range when the football game is expected to end and fans subsequently emerge from the stadium) and an area associated with the potentially disruptive external condition (e.g., a several block perimeter surrounding the stadium where the football game is scheduled). Method 700 may, in accordance with some embodiments of the present invention, access the database via network 110.

Method 700 continues, based upon checking the data received from autonomous vehicle 120 against contextual information (in operation 704), by determining a potentially disruptive event likely to have caused the deviation by autonomous vehicle 120 from the baseline vehicle behavior, as well as determining an area associated with the potentially disruptive event (operation 706). Using data available on mapping applications and other network/internet sources, for example, method 700 can infer if the autonomous vehicle is approaching areas that are attracting an unusually large number of obstacles at the time, e.g., near a stadium during (or shortly before or after) a game or concert, near a place of worship when it is letting out, near a school during recess or when it is letting out, near a playground of a park during park hours, near the scene of a recently reported traffic accident, etc.

In accordance with some embodiments of the present invention, method 700 determines a potentially disruptive event likely to have caused the deviation by autonomous vehicle 120 by identifying a particular one of the potentially disruptive external conditions included in the potentially disruptive external conditions file 172 has a time and an area associated therewith respectively corresponding to (i.e., encompassing) the time and the location of the deviation by autonomous vehicle 120. In some embodiments, method 700 marks that particular potentially disruptive external condition as the potentially disruptive event and marks the area associated with that particular potentially disruptive external condition as the area associated with the potentially disruptive event.

Method 700 continues, upon determining the potentially disruptive event and the area associated with the potentially disruptive event (in operation 706), by transmitting information instructing autonomous vehicle 120 to raise its awareness and sensor levels and/or operate in accordance with defensive driving habits while autonomous vehicle 120 is traveling in the area associated with the potentially disruptive event (operation 708). In some embodiments, method 700 may cause information to be communicated from server computer 160 to autonomous vehicle 120 instructing autonomous vehicle to increase an information gathering level of one or more sensors of sensor system 130 while autonomous vehicle 120 is traveling in an area associated with the potentially disruptive event and/or instructing autonomous vehicle 120 to operate in accordance with defensive driving habits file 170 (i.e., rather than according to regional operating mode 168) while autonomous vehicle 120 is traveling in an area associated with the potentially disruptive event.

In operation 708, the information transmitted to autonomous vehicle 120 instructing autonomous vehicle 120 to raise its awareness and sensor levels and/or operate in accordance with defensive driving habits is exemplary. In addition to, or in lieu of, instructing autonomous vehicle 120 to raise its awareness and sensor levels and/or operate in accordance with defensive driving habits, event zone management program 178 may in operation 708 instruct any autonomous vehicle approaching or traveling through the area associated with the potentially disruptive event to perform other functions, such as record one or more event metrics while autonomous vehicle is traveling in the area associated with the potentially disruptive event. The one or more event metrics recorded by autonomous vehicle 120 may be relayed as event metric data to server computer 160.

Method 700 continues by establishing a potential event zone by marking the area associated with the potentially disruptive event as the potential event zone (operation 710). In some embodiments, method 700 may copy the area associated with the potentially disruptive event into potential event zone file 174 as a potential event zone.

In addition, method 700 may optionally assign a strength/confidence level to the potential event zone. Method 700 may, for example, assign a strength/confidence level ranging between 0 (lowest strength/confidence level) and 10 (highest strength/confidence level) to the potential event zone. In some embodiments, method 700 may assign a predetermined initial value (e.g., 5) as the strength/confidence level of the potential event zone and record this predetermined initial value as strength/confidence level in potential event zone file 174. The strength/confidence level may be increased and/or decreased over time based on data subsequently received from other autonomous vehicles (i.e., data based on look-wide information gathered by other autonomous vehicles subsequently traveling in the potential event zone).

Method 700 continues, upon establishing a potential event zone (in operation 710), by transmitting information to a second autonomous vehicle (e.g., autonomous vehicle 140) instructing that particular autonomous vehicle to gather look-wide information using one or more sensors while that particular autonomous vehicle is traveling in the potential event zone (operation 712). The look-wide information may be gathered by one or more wide external sensors 151 of autonomous vehicle 140 each having a sensing field that covers an area outside of the immediate lane in which autonomous vehicle 140 is traveling. The one or more wide external sensors 151 may be activated, for example, in response to autonomous vehicle 140 receiving the aforementioned information from server computer 160. Data based on the look-wide information gathered are transmitted from autonomous vehicle 140 to server computer 160. For example, autonomous vehicle 140 may, in accordance with some embodiments, record one or more event metrics and relay the event metrics as event metric data to server computer 160.

In operation 712, the information transmitted to autonomous vehicle 140 instructing autonomous vehicle 140 to gather look-wide information is exemplary. In addition to, or in lieu of, instructing autonomous vehicle 140 to gather look-wide information, event zone management program 178 may in operation 712 instruct any autonomous vehicle approaching or traveling through the potential event zone to perform other functions. For example, event zone management program 178, working in conjunction with driving behavior modification program 180, may in operation 712 instruct autonomous vehicle 140 to operate in accordance with defensive driving habits while autonomous vehicle 140 is traveling in the potential event zone. Also, any autonomous vehicle that is traveling in a potential event zone may likewise use and update information about the potential event zone on server computer 160.

FIG. 8 is a flow diagram depicting operational steps of an event zone management program, in which an area associated with context determined to be applicable to an event trigger is marked as a potential event zone and in which the potential event zone is marked as a malicious event zone, in accordance with an embodiment of the present invention. Method 800 corresponds to an embodiment of event zone management program 178 of FIG. 1, which may be operating in conjunction with driving behavior modification program 180. Accordingly, method 800 is described below in the context of operating on server computer 160 within autonomous vehicle environment 100 of FIG. 1. To begin with, a first autonomous vehicle (e.g., autonomous vehicle 120 of FIG. 1) is operating in a given area. Autonomous vehicle 120 may, for example, operate in the given area according to regional operating mode 168. Regional operating mode 168 is a determined set of rules governing the behavior of autonomous vehicle 120 based on at least the location of autonomous vehicle 120 within a defined region and regional laws file 164 and regional habits file 166, both of which apply in the given area.

Method 800 receives data from autonomous vehicle 120 based on look-wide information gathered using one or more wide external sensors 131, wherein the look-wide information includes visual information gathered by one or more cameras in response to an event trigger (operation 802). The one or more wide external sensors 131 may be, for example, activated in accordance with method 500 illustrated in FIG. 5. Activation of the one or more wide external sensors 131 may be controlled locally within autonomous vehicle 120 (e.g., via onboard computer system 128) or remotely (e.g., via communication between server computer 160 and onboard computer system 128 using network 110). In some embodiments, the look-wide information is gathered by one or more wide external sensors 131 each having a sensing field that covers an area outside of the immediate lane in which autonomous vehicle 120 is traveling. In some embodiments, the visual information that is gathered covers an area substantially surrounding the first autonomous vehicle with a focus on a triggering entity.

When an event occurs such as a child running into the street, autonomous vehicle 120 may, as is conventional, immediately stop. Or, if a car veers into the lane in which autonomous vehicle 120 is traveling, autonomous vehicle 120 may, as is conventional, slow down or make one or more appropriate countermeasures. In addition to these conventional responses to the occurrence of such an event, in accordance with some embodiments of the present invention, method 800 may respond by activating one or more cameras to immediately snapshot the entire area around autonomous vehicle 120 with a focus on a triggering entity (e.g., the child and/or the child's face, or the veering car).

Method 800 continues, based on the data received from autonomous vehicle 120 (in operation 802), by determining whether context can be applied to the event trigger by analyzing the visual information gathered in response to the event trigger (operation 804). Intelligence can be applied to see if context can be made. Is there a ball? Is there a large group? Is the event trigger near a park or field? If context of a game and large number of children is found, for example, an area associated with the context (e.g., a perimeter surrounding the park or field) may be marked as a potential event zone (in operation 806, described below). Other autonomous vehicles entering the potential event zone will be made aware and heighten their caution level (in operation 808, described below).

Method 800 continues, based upon determining that context can be applied to the event trigger, by establishing a potential event zone by marking an area associated with the context as the potential event zone (operation 806). In some embodiments, method 800 may establish a potential event zone by storing the area associated with the context into potential event zone file 174, along with storing the visual information gathered in response to the event trigger.

Method 800 continues, upon establishing a potential event zone (in operation 806), by transmitting information to a second autonomous vehicle (e.g., autonomous vehicle 140) instructing that particular autonomous vehicle to gather look-wide information using one or more sensors while that particular autonomous vehicle is traveling in the potential event zone (operation 808). The look-wide information may be gathered by one or more wide external sensors 151 of autonomous vehicle 140 each having a sensing field that covers an area outside of the immediate lane in which autonomous vehicle 140 is traveling. The one or more wide external sensors 151 may be activated, for example, in response to autonomous vehicle 140 receiving the aforementioned information from server computer 160. Data based on the look-wide information gathered are transmitted from autonomous vehicle 140 to server computer 160.

In operation 808, the information transmitted to autonomous vehicle 140 instructing autonomous vehicle 140 to gather look-wide information is exemplary. In addition to, or in lieu of, instructing autonomous vehicle 140 to gather look-wide information, event zone management program 178 may in operation 808 instruct any autonomous vehicle approaching or traveling through the potential event zone to perform other functions. For example, event zone management program 178, working in conjunction with driving behavior modification program 180, may in operation 808 instruct autonomous vehicle 140 to operate in accordance with defensive driving habits while autonomous vehicle 140 is traveling in the potential event zone. Also, any autonomous vehicle that is traveling in a potential event zone may likewise use and update information about the potential event zone on server computer 160.

Method 800 continues by receiving subsequent data from autonomous vehicle 120 or autonomous vehicle 140 based on look-wide information gathered using one or more wide external sensors 131 or 151 of the respective autonomous vehicle 120 or 140 while traveling in the potential event zone, wherein the subsequent data includes visual information gathered by one or more cameras of the respective autonomous vehicle 120 or 140 in response to a subsequent event trigger (operation 810). The one or more wide external sensors 131 or 151 may be, for example, activated in accordance with method 500 illustrated in FIG. 5. Activation of the one or more wide external sensors 131 may be controlled locally within autonomous vehicle 120 (e.g., via onboard computer system 128) or remotely (e.g., via communication between server computer 160 and onboard computer system 128 using network 110). In some embodiments, the look-wide information is gathered by one or more wide external sensors 131 or 151 each having a sensing field that covers an area outside of the immediate lane in which the respective autonomous vehicle 120 or 140 is traveling. In some embodiments, the visual information gathered in response to the subsequent triggering event covers an area substantially surrounding the respective autonomous vehicle 120 or 140 with a focus on a triggering entity (e.g., the child and/or the child's face, or the veering car).

Method 800 continues, upon receiving data from the respective autonomous vehicle 120 or 140 (in operation 810), by determining whether the visual information gathered in response to the event trigger (included in the data received in operation 802, and stored in operation 806) matches the visual information gathered in response to the subsequent event trigger (included in the data received in operation 810) (operation 812). In accordance with some embodiments, visual identification software may be used to compare the triggering entity in the visual information gathered in response to the event trigger and the triggering entity in the visual information gathered in response to the subsequent event trigger to determine if the triggering entity is the same (e.g., same group of children, same child, or same car veering).

Method 800 continues, based upon determining that the visual information gathered in response to the event trigger matches the visual information gathered in response to the subsequent event trigger (in operation 812), by marking the potential event zone as a malicious event zone (operation 814). In some embodiments, method 800 may establish a malicious event zone by copying the information stored in the potential event zone file 174 into a malicious event zone file 176, along with storing the visual information gathered in response to the subsequent event trigger into the malicious event zone file 176.

Method 800 continues, based on marking the potential event zone as a malicious event zone (in operation 814), by pushing the information stored in the malicious event file 176 to all autonomous vehicles entering the malicious event zone (operation 816). Autonomous vehicles entering the malicious zone may, for example, visually identify the triggering entity and confirm behaviors if the events are still ongoing. In addition, once a certain repeatable threshold has been made, and it is clear that this event is intentional, method 800 may contact law enforcement or other appropriate entities. In some embodiments, autonomous vehicles entering the malicious event zone will record and upload visual information for law enforcement or insurance entities.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

One skilled in the art will appreciate that many variations are possible within the scope of the present invention. Thus, while the present invention has been particularly shown and described with reference to preferred embodiments thereof, it will be understood by those skilled in the art that these and other changes in form and details may be made therein without departing from the spirit and scope of the present invention.

What is claimed is:

1. A method for detecting risks and malicious activity towards autonomous vehicles in an autonomous vehicle network, comprising:
receiving, at a server computer, data from a first autonomous vehicle based on look-wide information gathered using one or more sensors of the first autonomous vehicle;
establishing, at the server computer, a potential event zone based on the data received from the first autonomous vehicle;
communicating, from the server computer, to a second autonomous vehicle information instructing the second autonomous vehicle to gather look-wide information using one or more sensors of the second autonomous vehicle while the second autonomous vehicle is traveling in the potential event zone.

2. The method as recited in claim 1, wherein the look-wide information is gathered by one or more wide external sensors of the first autonomous vehicle each having a sensing field that covers an area outside of an immediate lane in which the first autonomous vehicle is traveling, and wherein the one or more wide external sensors of the first autonomous vehicle are activated in response to a deviation by the first autonomous vehicle from a baseline vehicle behavior.

3. The method as recited in claim 2, wherein the deviation by the first autonomous vehicle from the baseline vehicle behavior is due to veering and/or sudden and frequent stops.

4. The method as recited in claim 2, further comprising checking, at the server computer, the data received from the first autonomous vehicle against contextual information describing external conditions within a region in which the first autonomous vehicle is traveling.

5. The method as recited in claim 4, further comprising determining, at the server computer, based on the checking operation, a potentially disruptive event likely to have caused the deviation by the first autonomous vehicle from the baseline vehicle behavior, as well as determining an area associated with the potentially disruptive event.

6. The method as recited in claim 5, further comprising communicating, at the server computer, to the first autonomous vehicle information instructing the first autonomous vehicle to increase an information gathering level of at least one of the one or more sensors of the first autonomous vehicle while the first autonomous vehicle is traveling in the area associated with the potentially disruptive event.

7. The method as recited in claim 5, further comprising communicating, at the server computer, to the first autonomous vehicle information instructing the first autonomous vehicle to operate in accordance with defensive driving habits while the first autonomous vehicle is traveling in the area associated with the potentially disruptive event.

8. The method as recited in claim 5, further comprising communicating, at the server computer, to the first autonomous vehicle information instructing the first autonomous vehicle to record one or more event metrics while the first autonomous vehicle is traveling in the area associated with the potentially disruptive event, and wherein the one or more event metrics are selected from the group consisting of a drive time of the first autonomous vehicle through the area associated with the potentially disruptive event, a proximity of a closest moving obstacle encountered by the first autonomous vehicle while traveling within the area associated with the potentially disruptive event, a density of obstacles encountered by the first autonomous vehicle while traveling within the area associated with the potentially disruptive event, and combinations thereof.

9. The method as recited in claim 8, further comprising receiving, at a server computer, event metric data from the first autonomous vehicle based on the one or more event metrics recorded by first autonomous vehicle.

10. The method as recited in claim 9, wherein establishing, at the server computer, a potential event zone based on the data received from the first autonomous vehicle includes marking the area associated with the potentially disruptive event as the potential event zone.

11. The method as recited in claim 10, wherein establishing, at the server computer, a potential event zone based on the data received from the first autonomous vehicle includes assigning a strength/confidence level to the potential event zone.

12. The method as recited in claim 11, further comprising:
receiving, at the server computer, data from the second autonomous vehicle based on the look-wide information gathered using the one or more sensors of the second autonomous vehicle while the second autonomous vehicle is traveling in the potential event zone;
updating, at the server computer, information about the potential event zone based on the data received from the second autonomous vehicle.

13. The method as recited in claim 12, wherein updating, at the server computer, information about the potential event zone based on the data received from the second autonomous vehicle includes updating the strength/confidence level assigned to the potential event zone.

14. The method as recited in claim 1, wherein the look-wide information includes visual information gathered by one or more cameras of the first autonomous vehicle in response to an event trigger, and wherein the visual information covers an area substantially surrounding the first autonomous vehicle with a focus on a triggering entity.

15. The method as recited in claim 14, further comprising determining, at the server computer, a context that can be applied to the event trigger and an area associated with the context by analyzing the visual information gathered in response to the event trigger.

16. The method as recited in claim 15, wherein establishing, at the server computer, a potential event zone based on the data received from the first autonomous vehicle includes marking the area associated with the context as the potential event zone in response to determining the context that can be applied to the event trigger.

17. The method as recited in claim 14, further comprising:
receiving, at the server computer, subsequent data from the first autonomous vehicle or the second autonomous vehicle based on look-wide information gathered using one or more sensors of the respective autonomous vehicle, wherein the subsequent data includes visual information gathered by one or more cameras of the respective autonomous vehicle in response to a subsequent event trigger, and wherein the visual information covers an area substantially surrounding the respective autonomous vehicle with a focus on a triggering entity;
determining, at the server computer, whether the visual information gathered in response to the event trigger matches the visual information gathered in response to the subsequent event trigger;
marking, at the server computer, the potential event zone as a malicious event zone in response to determining that the visual information gathered in response to the event trigger matches the visual information gathered in response to the subsequent event trigger.

18. The method as recited in claim 17, further comprising:
communicating, from the server computer, to one or more autonomous vehicles entering the malicious event zone and/or one or more third-party entities information associated with the malicious event zone.

19. A computer system, comprising:
a processor, a system memory, and a bus that couples various system components including the system memory to the processor, the computer system configured to perform a method comprising:
receiving data from a first autonomous vehicle based on look-wide information gathered using one or more sensors of the first autonomous vehicle;
establishing a potential event zone based on the data received from the first autonomous vehicle;
communicating to a second autonomous vehicle information instructing the second autonomous vehicle to gather look-wide information using one or more sensors of the second autonomous vehicle while the second autonomous vehicle is traveling in the potential event zone.

20. A computer program product for detecting risks and malicious activity towards autonomous vehicles in an autonomous vehicle network, the computer program product comprising a computer readable storage medium having program code embodied therewith, the program code executable by a processor or other programmable data processing apparatus to perform a method comprising:
receiving data from a first autonomous vehicle based on look-wide information gathered using one or more sensors of the first autonomous vehicle;
establishing a potential event zone based on the data received from the first autonomous vehicle;
communicating to a second autonomous vehicle information instructing the second autonomous vehicle to gather look-wide information using one or more sensors of the second autonomous vehicle while the second autonomous vehicle is traveling in the potential event zone.
